(19) United States
(12) Patent Application Publication
(10) Pub. No.: US 2016/0147966 A1
(43) Pub. Date: May 26, 2016

(54) APPARATUS AND METHOD FOR SETTING MULTI-HIERARCHY EVENT ALARM ACCORDING USER RESPONSE

(71) Applicant: KOREA INSTITUTE OF ORIENTAL MEDICINE, Daejeon (KR)

(72) Inventors: Hee Jeong Jin, Daejeon (KR); Young Seop Lee, Daejeon (KR); Si Woo Lee, Jeonju-si (KR); Eun Su Jang, Daejeon (KR); Jong Hyang Yoo, Daejeon (KR)

(21) Appl. No.: 14/946,494

(22) Filed: Nov. 19, 2015

(30) Foreign Application Priority Data
Nov. 20, 2014 (KR) 10-2014-0162469

(51) Int. Cl. G06F 19/00

(52) U.S. Cl. CPC G06F 19/3406

(57) ABSTRACT

Provided is a computing apparatus for performing an alarm processing by managing a plurality of events related to at least one of health information and Korean medicine mibyeong information based on a hierarchical structure, the apparatus including a database configured to store the plurality of events in a hierarchical structure, a hierarchical information manager configured to manage a first identifier indicating a current event hierarchy identifier adjusted by applying a user feedback on an event alarm provided in advance, and a processor configured to provide a first event related to the first identifier among the plurality of events, wherein the plurality of events is stored in the hierarchical structure such that an event index, an event hierarchy identifier, and an event description are related to one another for each of the events.

### CROSS-REFERENCE TO RELATED APPLICATION

The entire contents of Korean Patent Application No. 10-2014-0162469, filed on Nov. 20, 2014, in the Korean Intellectual Property Office, are incorporated herein by reference.

### BACKGROUND

1. Field of the Invention

Embodiments relate to an apparatus for providing health information and Korean medicine mibyeong information to a user, and more particularly, to a method in which a health information providing apparatus hierarchically classifies health information alarm events to adjust a degree of activation based on a user response.

2. Description of the Related Art

Recently, with a dissemination of a computing terminal such as a smartphone, a mobile operation system or an application may provide a function of an event alarm or event notification to a user. As an example, a healthcare application may provide health information to a user.

In general, a user may determine whether an alarm is to be accepted by setting an alarm to be On/Off for each application and/or an entire terminal. In response to the setting, the application may or may not provide information to the user. In this example, the event alarm may be uniformly set to be On/Off irrespective of an intention of the user and thus, a range of information provided to the user may be limited. As an example, in a case of an iPhone manufactured by Apple, for example, whether an event alarm is turned on or turned off, and an application of which an event alarm is allowed among installed applications may be set through a notification center menu setting while a function to adaptively adjust or optimize alarm information level in a single application is not provided therein.

### SUMMARY

According to an aspect, there is provided a computing apparatus for performing an event alarm related to at least one of health information and Korean medicine mibyeong information, the apparatus including a database configured to store a plurality of events related to at least one of health information and Korean medicine mibyeong information in a hierarchical structure, a hierarchical information manager configured to manage a first identifier indicating a current event hierarchy identifier adjusted by applying a user feedback on an event alarm provided in advance, and a processor configured to provide a first event related to the first identifier among the plurality of events, wherein the plurality of events is stored in the hierarchical structure such that an event index, an event hierarchy identifier, and an event description are related to one another for each of the events. As a non-limiting example, a level of hierarchical identifier related to an event description may increase according to an increase in a level of the event hierarchy identifier.

The processor may be configured to provide a first event description of the first event and a graphical user interface (GUI) object for receiving a user feedback on the first event. The GUI object may include a first object allocated to receive a positive response to the providing of the first event description and a second object allocated to receive a negative response to the providing of the first event description.

The hierarchical information manager may be configured to manage a first value indicating a cumulative counter value of the first object selected to correspond to the first identifier and a second value indicating a cumulative counter value of the second object selected to correspond to the first identifier. The hierarchical information manager may be configured to update the first identifier by increasing one level when the first value is greater than a first threshold, and update the first identifier by decreasing one level when the second value is greater than a second threshold.

The hierarchical information manager may be configured to manage a first value indicating a consecutive counter value of the first object consecutively selected to correspond to the first identifier and a second value indicating a consecutive counter value of the second object consecutively selected to correspond to the first identifier. The hierarchical information manager may be configured to update the first identifier by increasing one level when the first value is greater than a first threshold and update the first identifier by decreasing one level when the second value is greater than a second threshold.

According to another aspect, there is also provided a computing method in which a computing apparatus including at least one processor manages at least one event alarm of health information and Korean medicine mibyeong information, the method being performed by the at least one processor and the method including accessing a database storing a plurality of events related to at least one of the health information and the Korean medicine mibyeong information in a hierarchical structure, managing a first identifier indicating a current event hierarchy identifier adjusted by applying a user feedback on an event alarm provided in advance, and providing a first event related to the first identifier among the plurality of events, wherein the plurality of events is stored in the hierarchical structure such that an event index, an event hierarchy identifier, and an event description are related to one another for each of the events.

The providing may include providing a first event description of the first event and a GUI object for receiving a user feedback on the first event. The GUI object may include a first object allocated to receive a positive response to the providing of the first event description and a second object allocated to receive a negative response to the providing of the first event description.

The managing may include managing a first value indicating a cumulative counter value of the first object selected to correspond to the first identifier and a second value indicating a cumulative counter value of the second object selected to correspond to the first identifier. The computing method may further include updating the first identifier by increasing one level when the first value is greater than a first threshold and updating the first identifier by decreasing one level when the second value is greater than a second threshold.

The managing may include managing a first value indicating a consecutive counter value of the first object consecutively selected to correspond to the first identifier and a second value indicating a consecutive counter value of the second object consecutively selected to correspond to the first identifier. The computing method may further include updating the first identifier by increasing one level when the first value is greater than a first threshold and updating the first identifier by decreasing one level when the second value is greater than a second threshold.

According to still another aspect, there is also provided a program stored in a non-transitory computer-readable recording medium, the program configured to allow a computer to process an event alarm related to at least one of health information and Korean medicine mibyeong information, and the program including a set of instructions to access a database storing a plurality of events related to at least one of the health information and the Korean medicine mibyeong information in a hierarchical structure, a set of instructions to manage a first identifier indicating a current event hierarchy identifier adjusted by applying a user feedback on an event alarm provided in advance, and a set of instructions to provide a first event related to the first identifier among the plurality of events, wherein the plurality of events is stored in the hierarchical structure such that an event index, an event identifier, and an event description are related to one another for each of the events.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a computing apparatus according to an embodiment; FIGS. 2 through 5 illustrate examples of providing an event alarm and a graphical user interface (GUI) for receiving a user feedback according to an embodiment;

FIG. 6 illustrates an example of hierarchical event alarm according to an embodiment;

FIG. 7 is a flowchart illustrating a computing method according to an embodiment; and

FIG. 8 is a flowchart illustrating a process of determining whether an event level update is to be performed and performing an update.

### DETAILED DESCRIPTION

Reference will now be made in detail to example embodiments, examples of which are illustrated in the accompanying drawings, wherein like reference numerals refer to the like elements throughout.

Terminologies used herein are defined to appropriately describe the example embodiments of the present disclosure and thus may be changed depending on a user, the intent of an operator, or a custom. Accordingly, the terminologies must be defined based on the following overall description of this specification.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

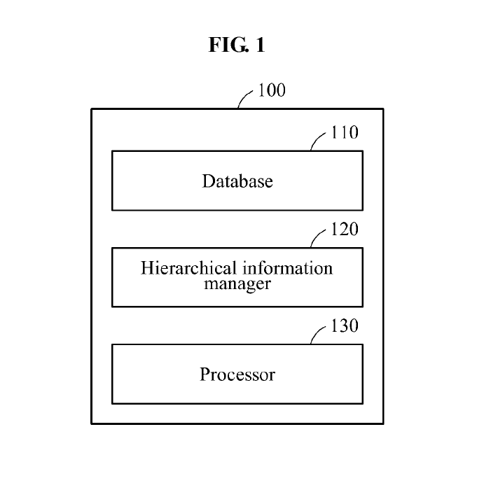

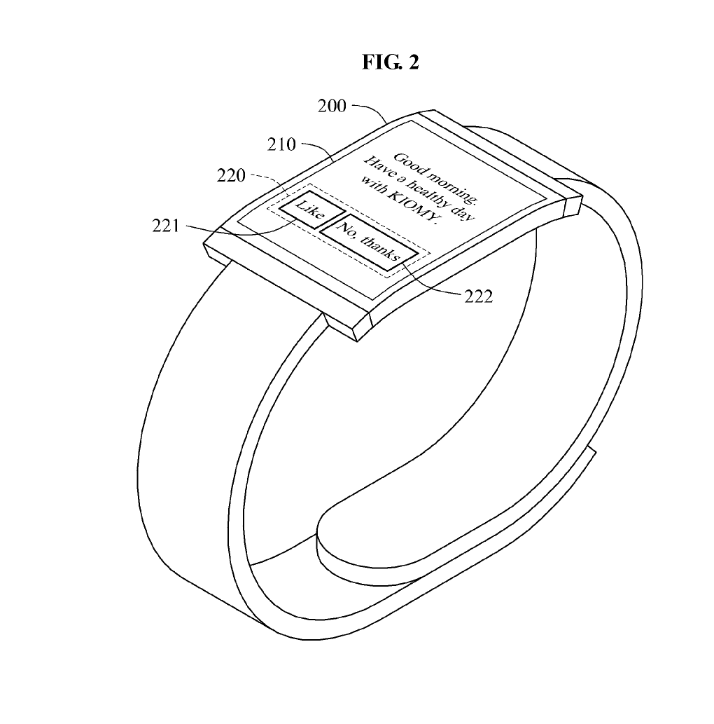

FIG. 1 is a block diagram illustrating a computing apparatus 100 according to an embodiment. The computing apparatus 100 may perform an event alarm related to at least one of health information and Korean medicine mibyeong information. In this disclosure, the term “mibyeong” may indicate a sub-health state in which various types of subjective symptoms are present while a particular disorder is not discovered through a medical examination. The computing apparatus 100 may include a database 110 configured to store a plurality of events related to at least one of the health information and the Korean medicine mibyeong information in a hierarchical structure. In the hierarchical structure, each of the events may have a plurality of data fields. The data fields may include a field for storing an event index, a field for storing an event hierarchy identifier, a field for storing an event description. For each of the event, the event index, the event hierarchy identifier, and the event description may be related to one another.

The hierarchical information manager 120 may store and manage a first identifier indicating a layer identifier corresponding to a hierarchical level, for example, a level of hierarchical depth for events, providing a current event alarm. Events of a level corresponding to the first identifier may be provided through the event alarm. In an example, a user feedback or a user response on or to an event alarm provided in advance may be applied to the first identifier. Through this, the first identifier may be adaptively adjusted or updated to have a higher or lower level. In this example, the first identifier may be adjusted or updated by the hierarchical information manager 120.

In an example, the hierarchical information manager 120 may manage a first value r1 indicating a cumulative counter value of a first object selected to correspond to the first identifier and a second value r2 indicating a cumulative counter value of a second object selected to correspond to the first identifier. In another example, the first value r1 may indicate a consecutive input counter value of the first object consecutively selected to correspond to the first identifier. Also, the second value r2 may indicate a consecutive input counter value of the second object consecutively selected to correspond to the first identifier.

The hierarchical information manager 120 may update the first identifier by increasing one level when the first value r1 is greater than a first threshold t1, and update the first identifier by decreasing one level when the second value r2 is greater than a second threshold t2. Through this, based on the user response, an event alarm hierarchical level may increase when the first identifier is increased by one level and decrease when the first identifier is decreased by one level.

The processor 130 may extract the event alarm of the level corresponding to the first identifier and provide the extracted event alarm. For example, concreteness and excursiveness of the event description may increase according to an increase in the level of the event hierarchy identifier. However, the disclosure is not limited thereto. Among the event stored in the hierarchical structure, a subsequent event alarm corresponding to current input information and a previous event may be provided at only a level corresponding to the first identifier. Related descriptions will also be provided with reference to FIG. 2.

The processor 130 may provide a first event description corresponding to the first event and a graphical user interface (GUI) object for receiving a user feedback/response corresponding to the first event. As an example, the GUI object may include a first graphical object allocated to receive a positive response, for example, “like”, to the providing of the first event description. Also, the GUI object may include a second graphical object allocated to receive a negative response, for example, “no, thank you”, to the providing of the first event description. Descriptions related to the aforementioned graphical objects will also be provided with reference to FIGS. 2 through 5.

FIGS. 2 through 5 illustrate examples of providing an event alarm and a graphical user interface (GUI) for receiving a user feedback according to an embodiment.

As described above, an event alarm may include one of N identifiers corresponding to a level 0 through a level N−1, N being a natural number greater than 1. A hierarchy may be differently set based on a setting or type of application. As an example, among event alarm later identifiers, 0 may be a basic alarm provided while the application is executed and correspond to a level informing of a start of a service and/or an application, but is not limited thereto. The higher the hierarchy identifier, for example, closer to N−1, the more detailed and concise an alarm event description. A user may be satisfied with currently provided information and desire to additionally receive more detailed information. Alternatively, the user may be irritated by an event alarm and desire to avert disturbances during a private time.

In example embodiments, an event alarm hierarchy level may be increased or decreased in response to a feedback on a status of a user, thereby providing an event alarm that adaptively and mutually communicates with the user. Also, contents of an event alarm may be provided on a display, for example, through a push alarm. Simultaneously with or subsequently to the event alarm, a GUI object may be provided such that the user inputs a feedback on whether the event alarm of the corresponding level is satisfactory or unsatisfactory. For example, icon buttons “Like” and “No, thanks” may be provided as the GUI object.

Referring to FIG. 2, an information terminal 200 configured to perform a computing function may display an event description 210, for example, “Good morning. Have a healthy day with KIOMY.” corresponding to an event alarm hierarchy level 0. Here, KIOMY may be a name of an application. For example, KIOMY may be understood as a name of a health management/mibyeong information event alarm application developed and distributed by the Korea Institute of Oriental Medicine. Since the event alarm hierarchy level is 0, the user wearing the information terminal 200 in the morning may receive notification that a corresponding application is executed.

The user may respond whether an execution of the application is acceptable or inacceptable through a GUI object 220. When the user determines to receive an event alarm of the application, the user may select a button 221, for example, “Like”. When the user determines not to receive the event alarm of the application, the user may select a button 222, for example “No, thanks” When the user is busy or defers a determination, the user may not input a feedback and ignore the event alarm. When the user input is absent, various type of processing may be performed based on a predetermined method. As an example, an event alarm level may be maintained until a user input is provided and an event corresponding to the same event level may be provided again. In this example, the same event may be provided repetitively. Alternatively, an event having the same event level and a differing event description may be provided. Also, the processing may be performed at a predetermined level based on an event level. For example, in an event 0, the processing may be performed at an event level 1 irrespective of a presence of a user input.

An identifier level indicating a current event alarm hierarchy may be consistently managed. As an example, at a current identifier, for example, an alarm level 1, count information r1 corresponding to the number of times that a button “Like” is selected and count information r2 corresponding to the number of times that a button “No, thanks” is selected may be stored and managed.

In an example, r1 or r2 may be obtained by accumulating positive/negative information selection values from a start of the current level. In another example, r1 or r2 may indicate the number of times that an input is received consecutively. Also, various types of counting may be performed based on an example.

In an example, when a positive feedback count r1 is greater than a predetermined threshold t1, it is estimated that the user accepts a corresponding level of event alarm and desires to receive more detailed information. Thus, a higher event alarm level may be provided to the user. Through this, more detailed and more specific information having a higher event hierarchy identifier may be provided as an event alarm. Depending on an example, an increase in an event alarm providing frequency may also be applicable thereto.

When a negative feedback count r2 is greater than a predetermined threshold t2, it is estimated that the user is annoyed with the corresponding level of event alarm and desire to keep a private time from a disturbance. Thus, a lower event alarm level may be provided to the user. Through this, common and less detailed information having a lower event alarm hierarchy identifier may be provided as an event alarm. Depending on an example, a decrease in an event alarm providing frequency may also be applicable thereto. An adjustment/update of the event alarm level may be performed only between a minimum value 0 and a maximum value N−1.

Events provided in a health information provision and health management event alarm application may be represented as an example in Table 1.

TABLE 1

| Event | Event | |
|---|---|---|
| index | identifier | Event description |
| I1 | 0 | Turn-on system |
| I2 | 0 | Turn-off system |
| I3 | 1 | Breakfast time |
| I4 | 1 | Reached 3000 steps 7000 steps remain to goal |
| I5 | 1 | Sit still for 2 hours Move your body |
| I6 | 2 | Walking time exceeds 1 hour Take a break |
| I7 | 2 | Running time exceeds 30 minutes Take a break and get |
| | | some water |
| I8 | 2 | Body temperature keeps descending Pay attention to |
| | | body temperature maintenance |
| I9 | 3 | Body temperature variation is beyond recommended |
| | | range Go indoors immediately and take a rest |

In Table 1, alarm events may be hierarchized. An event index may correspond to a unique number for identifying a plurality of events, and an event hierarchy identifier may indicate hierarchical information on a level of a corresponding event. An event description may include, for example, a text, an image, and/or sound of an event to be provided to the user in a form of, for example, a push alarm. Depending on an example, the event description may include, for example, hyperlink information and video clip playback information. According to an increase in a value of the event hierarchical identifier, the event alarm may be more detailed.

An index I3 of FIG. 1 may be provided with reference to FIG. 3. An event description 310 “Breakfast time, eat slowly” may be displayed and a GUI object 320 may be provided simultaneously. The aforementioned count numbers r1 and r2 may be affected when the user selects a positive feedback object 321 or a negative feedback object 322. r1 and r2 exceed threshold t1 and t2 during a management of r1 and r2, a current hierarchical identifier may be increased or decreased. In FIG. 3, descriptions will be provided based on an example in which a threshold is not exceeded and a current hierarchy identifier is maintained as a current state so as to be progressed to an example of FIG. 4.

Based on a scenario and a structural link of an event hierarchy, events may be provided with reference to FIG. 4, as follows. In this example, an event index I5 may be provided. Here, the event index I5 may have the same event index and the event hierarchy identifier, 1, when compared to the event index I3 of FIG. 3. Similarly, a GUI object 420 may be provided while an event description 410, for example, “sit still for 2 hours, move your body” is displayed. Subsequently, the user may select a positive feedback object 421 or a negative feedback object 422, which may affect the count numbers r1 and r2. When r1 and r2 are exceed thresholds t1 and t2 during a management of r1 and r2, a current hierarchy identifier may be increased or decreased. In an example of FIG. 4, it is assumed that a positive feedback count number r1 exceeds the threshold t1 such that the event hierarchy identifier is increased by 1.

FIG. 5 illustrates that an event description 510 of an event index I7 is provided to a user running according to guidance. An event description, for example, “running time exceeds 30 minutes, take a break and get some water” may be displayed and a GUI object 520 may be provided. A user may select a positive feedback object 521 or a negative feedback object 522, which may affect the count numbers r1 and r2. As the foregoing, an event hierarchy identifier may increase or decrease in response to a user feedback, and may be adaptively optimized and provided to the user.

Thereafter, when a negative feedback count number r2 exceeds the threshold t2, the event hierarchy identifier may decrease to be 1. In this example, an event I4 or I5 may not be provided as an alarm although the user is walking for an hour or running for 30 minutes.

Table 1 may be provided as an example of an application providing health information and health management information event and thus, this disclosure is not limited thereto. As another example, event may be provided in an application for a Korean mibyeong diagnosis and management system as follows.

TABLE 2

| Event index | Event hierarchy level | Event description |
|---|---|---|
| I1 | 0 | Turn-on system |
| I2 | 0 | Turn-off system |
| I3 | 1 | Input basic information |
| I4 | 1 | Mibyeong diagnosis starts |
| I5 | 1 | Check your mibyeong yangsaeng |
| I6 | 2 | Meditation time |
| I7 | 2 | Sleeping time |
| I8 | 2 | Have small lunch |
| I9 | 3 | Check any change after starting |
| | | yangsaeng |

The related descriptions provided above may also be applicable to an event alarm provision and an adaptive adjustment procedure of an event hierarchy level. An event description may be an only difference therebetween. For a mibyeong diagnosis and management application, the event hierarchy level may be set to have a level between 0 and 3. An event related to an execution/termination of the application may be set as a level 0. Basic information requested for a mibyeong diagnosis may be set as a level 1. A description related to yangsaeng indicating a treatment for a mibyeong may be set as a level 2. A description related to a result of yangsaeng may be set as a level 3. In this disclosure, the term “yangsaeng” may indicate, for example, an effort to comfort a body and mind, and avoid a disease to live longer and healthier.

The mibyeong diagnosis and management application may be executed with an event alarm corresponding to the level 1. Since the mibyeong diagnosis is the most significant part of the mibyeong diagnosis and management application, an initial alarm level may be set as the level 1. Also, when the user executes the mibyeong diagnosis and management application, an alarm indicating a start of a basic level 0 and an alarm 13 corresponding to the level 1 for the mibyeong diagnosis may be consecutively provided in sequence.

When the positive feedback count number r1 exceeds the threshold t1 during a system execution, an alarm level may be increased to be the level 2 such that an alarm related to the yangsaeng provide notification indicating, for example, a time to abide by the yangsaeng. When the negative feedback count number r2 exceeds the threshold t2, the alarm level may be sequentially decreased to be 0. In this example, the alarm level may not be decreased after reaching the level 0 despite an increase in the negative feedback count number.

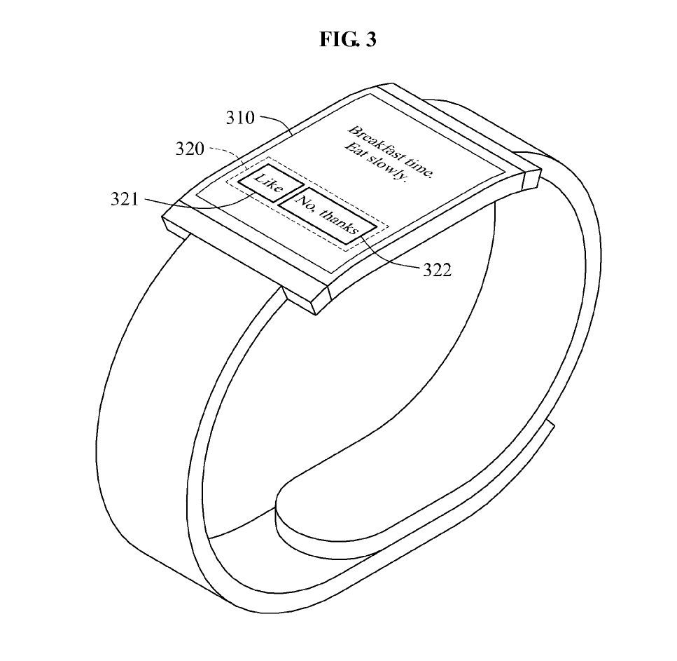

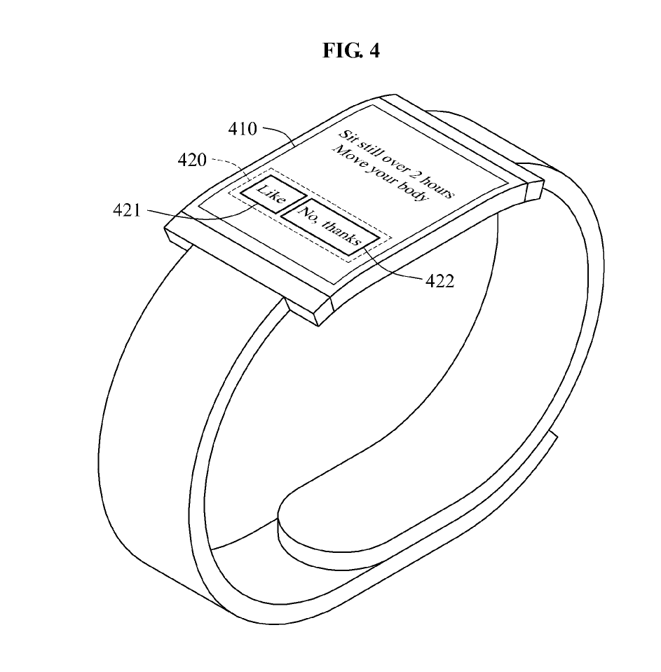

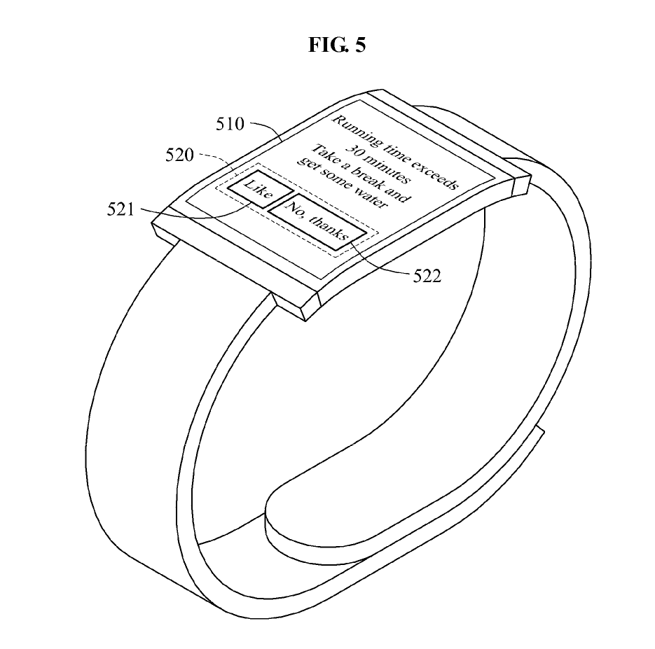

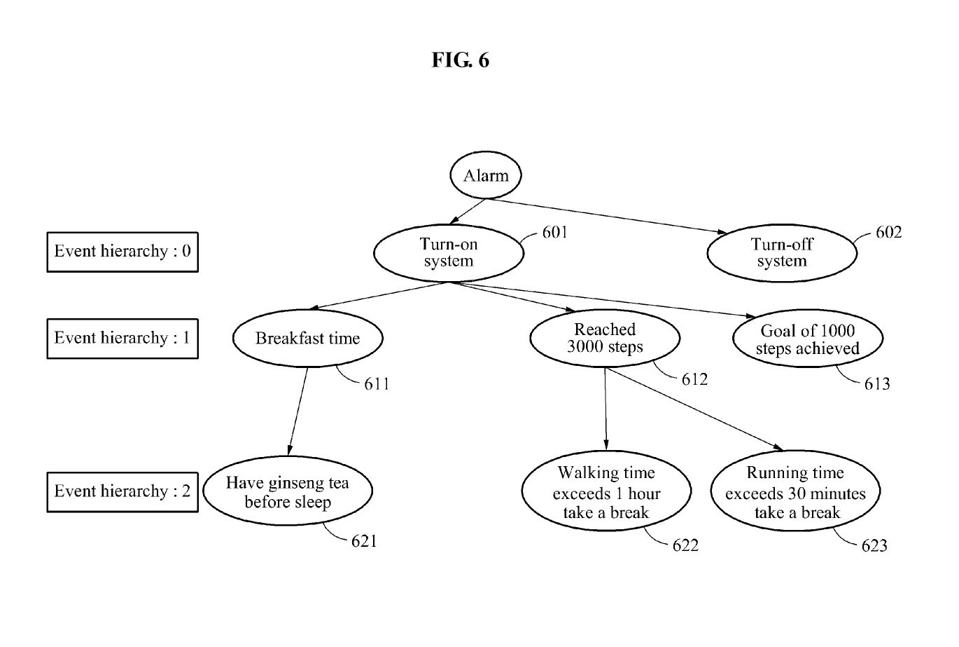

FIG. 6 illustrates an example of hierarchical event alarm according to an embodiment. Events 601 and 602 indicating a system start and a system termination may be included in an event hierarchy level 0 as an example, but is not limited thereto. When a user provides a positive feedback exceeding or equal to a threshold on a system start event, a current event hierarchy level L may increase by 1. In this example, an event hierarchy may be 1 and thus, events 611, 612, and 613 of a level 1 may be provided. Also, when the current event hierarchy level L increases again based on a user response, events 621, 622, and 623 may be provided. Although FIG. 6 illustrates events in a tree structure as an example, the disclosure is not limited thereto. Thus, an event structure may be hierarchized in various types of data structures.

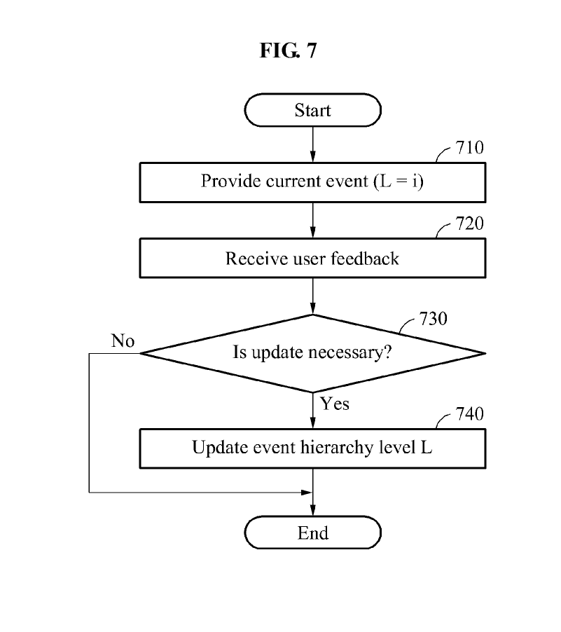

FIG. 7 is a flowchart illustrating a computing method according to an embodiment. In operation 710, an event having a current event hierarchy level, for example, L=i, may be provided. The event may be provided by a computing apparatus accessing a database configured to store a plurality of events related to at least one of health information and Korean mibyeong information in a hierarchical structure. The descriptions related to an example of providing an event description are also provided with reference to FIGS. 2 through 5. Here, as described with reference to FIG. 2, the hierarchical structure may store a plurality of events in which an event index, an event hierarchy level, and an event description are related to one another for each of the events.

In operation 720, through user response feedback receiving GUIs provided with the event descriptions, a user feedback on an event alarm provided in advance may be received. In operation 730, whether a current event hierarchy level L is to be changed, for example updated, may be determined while a positive count r1 and a negative count r2 of the user feedback are managed. An operation of updating the current event hierarchy level L may be understood as an operation of increasing or decreasing an event hierarchy level provided currently.

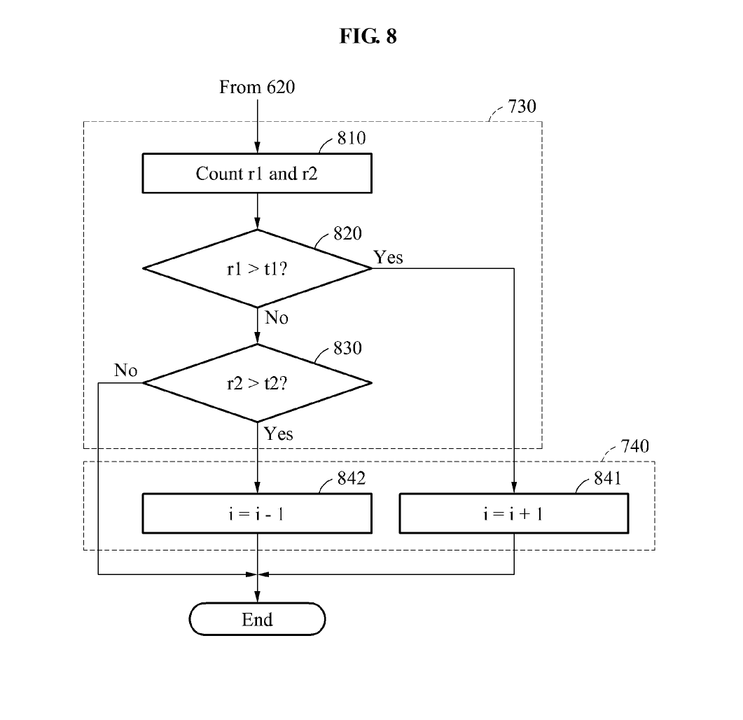

In operation 740, the event hierarchy level L may be updated when the event hierarchy level L is to be updated. Otherwise, a subsequent event may be provided in a state in which the event hierarchy level L is maintained as a current level. Descriptions related to operation 730 of determining whether the update is to be performed and operation 740 of performing the update will also be provided with reference to FIG. 8.

FIG. 8 is a flowchart illustrating a process of determining whether an event hierarchy level update is to be performed and performing an update. In operation 810, a number of positive feedbacks input by a user through a GUI object may be applied to be a count r1 and a number of negative feedbacks may be applied as a count r2. In an example, the count r1 and the count r2 may be a cumulative positive count value obtained after a current level L reaches i. In another example, a consecutive input value may be applied to be the count r1 or the count r2. For example, when a negative feedback is received in a state in which the count r1 is less than or equal to a threshold t1, the count r1 may be reset as an initial value of 0. Alternatively, in response to the receiving of the negative feedback, the count r1 may be calculated by decreasing a previous cumulative value by 1.

In operation 820, whether the count r1 of the positive feedback exceeds the threshold t1 may be determined. When the count r1 exceeds the threshold t1, i may increase by 1 to perform an update on an event hierarchy level L in operation 841. Through this, an event hierarchy level may also increase and thus, the event may be provided more specifically and frequently.

Conversely, when the count r1 does not exceed the threshold t1, whether the count r2 exceeds a threshold t2 may be determined in operation 830. When the count r2 exceeds the threshold t2, i may decrease by 1 to perform an update on the event hierarchy level L in operation 842. Through this, an event hierarchy level may also decrease and thus, the event may be provided less specifically and frequently. A subsequent event may be provided based on a final value of L when the update is performed on the event hierarchy level L in operations 841 and 842, or when the count r2 does not exceed the threshold t2 in operation 830.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A computing apparatus comprising:
a database configured to store a plurality of events related to at least one of health information and Korean medicine mibyeong information in a hierarchical structure;
a hierarchical information manager configured to manage a first identifier indicating a current event hierarchy identifier adjusted by applying a user feedback on an event alarm provided in advance; and
a processor configured to provide a first event related to the first identifier among the plurality of events,
wherein the plurality of events is stored in the hierarchical structure such that an event index, an event hierarchy identifier, and an event description are related to one another for each of the events.

2. The apparatus of claim 1, wherein the processor is configured to provide a first event description of the first event and a graphical user interface (GUI) object for receiving a user feedback on the first event.

3. The apparatus of claim 2, wherein the GUI object comprises a first object allocated to receive a positive response to the providing of the first event description and a second object allocated to receive a negative response to the providing of the first event description.

4. The apparatus of claim 3, wherein the hierarchical information manager is configured to manage a first value indicating a cumulative counter value of the first object selected to correspond to the first identifier and a second value indicating a cumulative counter value of the second object selected to correspond to the first identifier.

5. The apparatus of claim 4, wherein the hierarchical information manager is configured to update the first identifier by increasing one level when the first value is greater than a first threshold, and update the first identifier by decreasing one level when the second value is greater than a second threshold.

6. The apparatus of claim 3, wherein the hierarchical information manager is configured to manage a first value indicating a consecutive counter value of the first object consecutively selected to correspond to the first identifier and a second value indicating a consecutive counter value of the second object consecutively selected to correspond to the first identifier.

7. The apparatus of claim 6, wherein the hierarchical information manager is configured to update the first identifier by increasing one level when the first value is greater than a first threshold and update the first identifier by decreasing one level when the second value is greater than a second threshold.

8. A computing method in which a computing apparatus comprising at least one processor manages at least one event alarm of health information and Korean medicine mibyeong information, the method being performed by the at least one processor and the method comprising:
accessing a database storing a plurality of events related to at least one of the health information and the Korean medicine mibyeong information in a hierarchical structure;
managing a first identifier indicating a current event hierarchy identifier adjusted by applying a user feedback on an event alarm provided in advance; and
providing a first event related to the first identifier among the plurality of events,
wherein the plurality of events is stored in the hierarchical structure such that an event index, an event hierarchy identifier, and an event description are related to one another for each of the events.

9. The method of claim 8, wherein the providing comprises providing first event description of the first event and a graphical user interface (GUI) object for receiving a user feedback on the first event.

10. The method of claim 9, wherein the GUI object comprises a first object allocated to receive a positive response to the providing of the first event description and a second object allocated to receive a negative response to the providing of the first event description.

11. The method of claim 10, wherein the managing comprises managing a first value indicating a cumulative counter value of the first object selected to correspond to the first identifier and a second value indicating a cumulative counter value of the second object selected to correspond to the first identifier.

12. The method of claim 11, further comprising:
updating the first identifier by increasing one level when the first value is greater than a first threshold and updating the first identifier by decreasing one level when the second value is greater than a second threshold.

13. The method of claim 12, wherein the managing comprises managing a first value indicating a consecutive counter value of the first object consecutively selected to correspond to the first identifier and a second value indicating a consecutive counter value of the second object consecutively selected to correspond to the first identifier.

14. The method of claim 13, further comprising:
updating the first identifier by increasing one level when the first value is greater than a first threshold and updating the first identifier by decreasing one level when the second value is greater than a second threshold.

15. A program stored in a non-transitory computer-readable recording medium, the program configured to allow a computer to process an event alarm related to at least one of health information and Korean medicine mibyeong information, and the program comprising:
a set of instructions to access a database storing a plurality of events related to at least one of the health information and the Korean medicine mibyeong information in a hierarchical structure;
a set of instructions to manage a first identifier indicating a current event hierarchy identifier adjusted by applying a user feedback on an event alarm provided in advance; and
a set of instructions to provide a first event related to the first identifier among the plurality of events,
wherein the plurality of events is stored in the hierarchical structure such that an event index, an event identifier, and an event description are related to one another for each of the events.
